(19) United States
(12) Patent Application Publication
(10) Pub. No.: US 2005/0075144 A1
(43) Pub. Date: Apr. 7, 2005

(54) Information service system for vehicle

(75) Inventors: Toshiro Muramatsu, Zushi-shi (JP); Norimasa Kishi, Yokohama-shi (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/954,180

(22) Filed: Oct. 1, 2004

(30) Foreign Application Priority Data
Oct. 2, 2003 (JP) P2003-344351

(51) Int. Cl. G06F 7/00

(52) U.S. Cl. 455/569.2; 701/1; 705/7

(57) ABSTRACT

A service terminal 3 accesses a vehicle 2 by using a service provider ID and a service ID. When the access to the vehicle 2 is authenticated, vehicle information that is necessary to provide a service of which utilization is applied for is read out. The read information is encrypted using an encryption key, and the encrypted information is transmitted to the service terminal 3. With this arrangement, the access to an in-vehicle network can be managed for each service provider while maintaining security. Therefore, vehicle equipment exclusive for each service needs not be installed. Consequently, workload and cost of both the service provider and a user who receives the service can be reduced.

### BACKGROUND OF THE INVENTION

The present invention relates to an information service system for vehicle that obtains vehicle information such as mileage information and breakdown record information from an on-board equipment of a vehicle, and provides various kinds of services such as a price assessment of a used car to a vehicle user by using the obtained vehicle information. More specifically, the invention relates to a technique of reducing workload and cost of a service provider and a user by managing for each service provider the access to the on-board equipment.

In recent years, there are many proposals of an information service system for vehicle that obtains vehicle information from an on-board equipment of a vehicle (hereinafter described as vehicle equipment) and provides various kinds of services by using the obtained vehicle information. There are also commercialized information service systems for vehicle that obtain positional information of a vehicle from a global positioning system (GPS) unit installed on the vehicle and that provide security services of the vehicle by using the obtained positional information.

### SUMMARY OF THE INVENTION

However, according to the conventional information service system for vehicle, a user needs to prepare exclusive vehicle equipment to receive the service. When the user wants to receive a plurality of services at the same time, a plurality of vehicle equipments must be used redundantly in some cases. Assuming that the user wants to receive services from a company A and a company B, even if both the companies A and B are service providers using the information obtained from the GPS unit, the user needs to prepare separate GPS units of the company A and the company B. Therefore, according to the conventional information service system for vehicle, the user must bear much workload and cost to receive the services.

The service provider can usually obtain vehicle information from an in-vehicle network in order to provide a service. However, from the security viewpoint, the service provider cannot directly access the in-vehicle network. Consequently, vehicle equipment needs to be installed for each service. Therefore, much workload and cost are necessary to provide services to the user.

The present invention has been achieved to solve the above problems. It is an object of the invention to provide an information service system for vehicle that can reduce workload and cost of both a service provider who provides a service by using vehicle information, and a user who receives the service.

In order to achieve the above object, an information service system for vehicle according to the present invention has the following configuration. To obtain vehicle information from vehicle equipment, a first processor installed at the side of a service provider transmits identification information given from a second processor, to a vehicle. The vehicle specifies the vehicle information to be transmitted to the first processor, according to the identification information received from the first processor and accessible information related to the identification information. The vehicle transmits the specified vehicle information to the first processor.

### BRIEF DESCRIPTION OF THE DRAWINGS

FIG. 1 is a schematic view of a configuration of an information service system for vehicle according to one embodiment of the present invention;

FIG. 2 is a block diagram of a configuration of a vehicle in the information service system for vehicle shown in FIG. 1;

FIG. 3 is a block diagram of a configuration of a manager terminal device in the information service system for vehicle shown in FIG. 1;

FIG. 4 is a flowchart of the operation of the information service system for vehicle shown in FIG. 1; and

FIG. 5 is a schematic view for explaining the operation of the information service system for vehicle shown in FIG. 1.

### DETAILED DESCRIPTION OF THE PREFERRED EMBODIMENTS

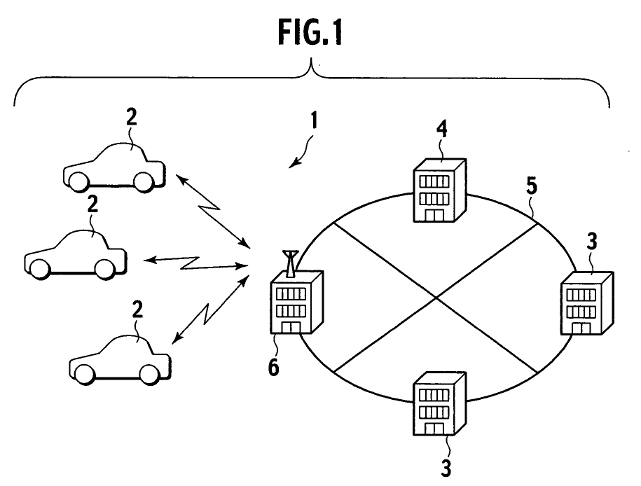

The present invention can be applied to an information service system for vehicle that obtains vehicle information from a vehicle and provides various kinds of services to a vehicle user by using the obtained vehicle information, as shown in FIG. 1. The configuration and operation of an information service system for vehicle according to the embodiment of the present invention will be explained in detail with reference to the drawings.

Configuration of the Information Service System for Vehicle

The configuration of an information service system for vehicle according to the embodiment of the present invention will be explained first with reference to FIG. 1.

As shown in FIG. 1, an information service system for vehicle 1 according to the embodiment of the present invention has service provider terminal devices 3 (hereinafter abbreviated as service terminal 3) installed at the side of service providers who provide various kinds of services to users by using vehicle information obtained from vehicles 2 owned by users, and a manager terminal device 4 (hereinafter abbreviated as managing terminal 4) installed at the side of a manager who manages the access of the service providers to the vehicles 2 to obtain the vehicle information. The service terminals 3 and the managing terminal 4 are connected together to be able to perform information-communication with each other via the Internet or an electric communication line 5 such as a telephone communication network. Further, the service terminals 3 and the managing terminal 4 are structured to be able to perform information-communication with the vehicles 2 via a communication apparatus 6 of a telecommunications carrier connected to the electric communication line 5. The service terminals 3 and the managing terminal 4 function as the first and the second processors according to the present invention respectively.

Configuration of the Vehicle

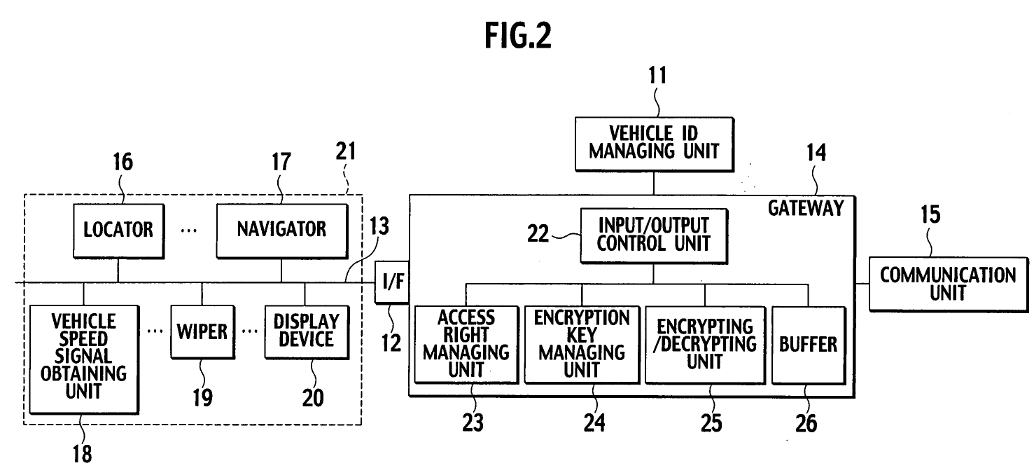

As shown in FIG. 2, each vehicle 2 has a vehicle ID managing unit 11 that stores an inherent vehicle ID (identifier) given to the vehicle 2, a gateway 14 that is connected to an in-vehicle network 13 via an interface (I/F) 12 and controls information-communications between the service terminals 3 and the managing terminal 4, and a communication unit 15 that is connected to the gateway 14, and carries out radio communications with the service terminals 3 and the managing terminal 4 by using communication apparatuses such as a portable telephone, a packet telecommunication apparatus, a radio LAN (Local Area Network), and a DSRC (Dedicated Short Range Communication).

The in-vehicle network 13 is connected with a plurality of vehicle equipments (hereinafter abbreviated as a vehicle equipment group) 21 such as a locator 16 that obtains vehicle positional information, a navigator 17, a speed signal obtaining unit 18, a wiper 19, and a display device 20. The gateway 14 has an input/output control unit 22 that controls information transmitted/received via the communication unit 15, an access right managing unit 23 that controls the access to the vehicle equipment group 21 connected to the in-vehicle network 13, an encryption key managing unit 24 that stores an encryption key for encrypting/decrypting the information transmitted/received via the communication unit 15, an encrypting/decrypting unit 25 that encrypts/decrypts the information by using the encryption key stored in the encryption key managing unit 24, and a buffer 26 that temporarily stores various kinds of information.

The vehicle ID stored in the vehicle ID managing unit 11 may be any kind of information such as a manufacturing number, a number given irrelevantly to the manufacturing number, and an inherent IP address so long as the vehicle ID is information inherent to each vehicle. The access right managing unit 23 stores a center ID and an access right setting ID given in advance inherently to the manager at the time of shipment from the plant. The information stored in the access right managing unit 23 and the encryption key managing unit 24 can be changed only when the manager accesses by using the center ID and the access right setting ID.

Configuration of the Managing Terminal

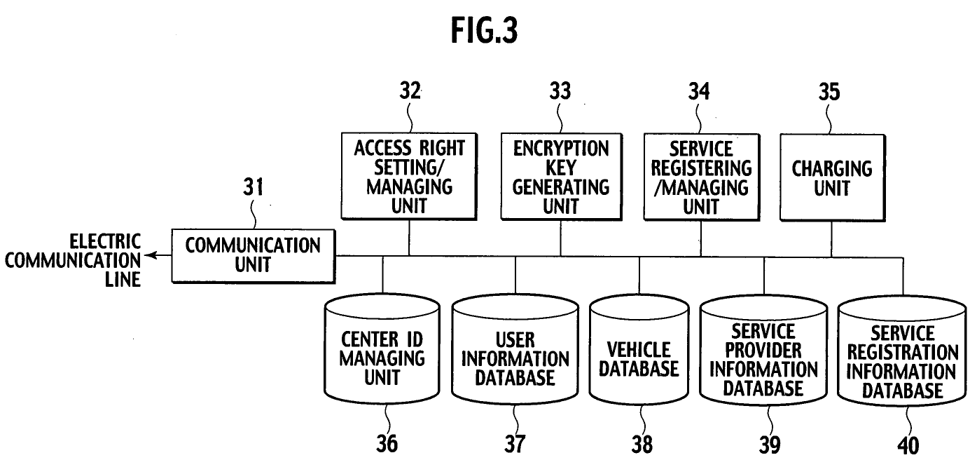

As shown in FIG. 3, the managing terminal 4 has a communication unit 31 that carries out radio communications with the vehicles 2 and the service terminals 3 via the electric communication line 5, an access right setting/managing unit 32 that stores the access right setting ID given inherently to the manager, an encryption key generating unit 33 that generates the encryption key to encrypt/decrypt the information transmitted/received via the communication unit 31, a service registering/managing unit 34 that manages the services provided by the service providers, and a charging unit 35 that charges the service providers based on the information stored in a service registration information database 40.

Further, the managing terminal 4 has a center ID managing unit 36 that stores the center ID given inherently to the manager, a user information database (DB) 37 that stores user individual information of the vehicles 2 generated based on data at the vehicle selling time and data at the vehicle registration time, a vehicle database (DB) 38 that stores for each vehicle ID the information of the user vehicles 2 generated based on data at the vehicle production time, a service provider information database (DB) 39 that stores contents of services provided (service contents), vehicle information contents necessary to be obtained to provide the services, and information to be transmitted to the vehicles 2, for each service provider ID given inherently to each service provider, and a service registration information database (DB) 40 that stores the vehicle IDs, the service provider IDs, the service contents, and the service IDs by relating these IDs and the service contents to each other.

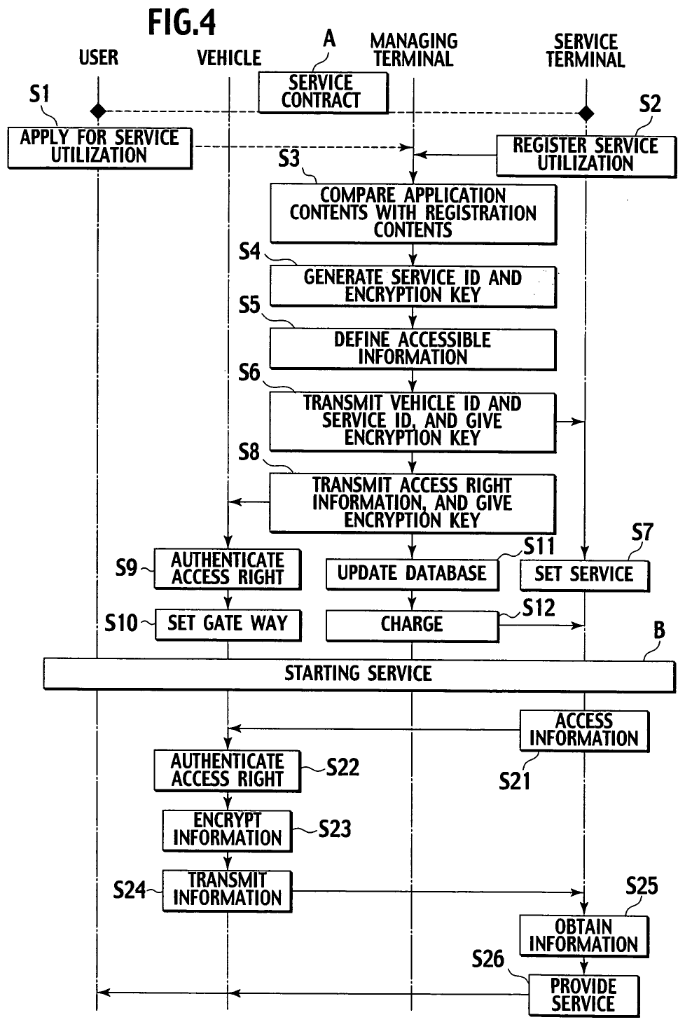

The information service system for vehicle 1 having the above configuration executes the following service contract processing and service provision processing, and manages the access to the in-vehicle network 13 for each service provider while maintaining security. With this arrangement, the information service system for vehicle 1 reduces workload and cost of the service providers and the users who receive the services. The operation of the information service system for vehicle 1 that executes the service contract processing and the service provision processing will be explained below with reference to the flowchart shown in FIG. 4.

Operation of the Information Service System for Vehicle

The information service system for vehicle 1 executes broadly two types of processing: a service contract processing A for carrying out various kinds of contract processing that are necessary to provide the services to the users who own the vehicles 2; and a service provision processing B for providing the services to the users whose service contract processing A is finished. The information service system for vehicle 1 will be explained below in the order of the service contract processing A and the service provision processing B.

Service Contract Processing

The operation of the information service system for vehicle 1 that executes the service contract processing A will be explained first with reference to the flowchart shown in FIG. 4.

The service contract processing A is executed as follows. According to the operation of the service provider, the service terminal 3 first transmits to the managing terminal 4 via the electric communication line 5, the service contents of the service provider, the vehicle information contents necessary to be obtained to provide the service, and the information contents to be transmitted to the vehicle 2. On the other hand, when the managing terminal 4 receives the information from the service terminal 3, the manager assesses the service provider based on the received information. The manager decides whether the access to the vehicle 2 can be permitted (i.e., whether the provision of the service can be permitted).

When the access to the vehicle 2 is permitted, following the manager operation, the service registering/managing unit 34 generates the service provider ID inherent to the service provider, and registers the information received from the service terminal 3, together with the service provider ID, into the service provider information database 39.

The service provider registered in the service provider information database 39 and the user who owns the vehicle 2 concludes the contract in this way. Then, at step S1, the user transmits to the managing terminal 4, the own individual information, the information of the owned vehicle 2, the information of the service provider from whom the user receives the service, and the service contents to be received from the service provider. In this way, the user applies to the manager for the reception of the service from the service provider (application for service utilization).

At step S2, following the service provider operation, the service terminal 3 transmits to the managing terminal 4 the individual information of the user to whom the service is to be provided, and the information of the vehicle 2 owned by the user, together with the service provider ID. In this way, the service terminal 3 notifies to the managing terminal 4, the provision of the service to the vehicle 2 under the user management according to the concluded contract contents (registration of service utilization).

In this way, the application for service utilization and the registration of service utilization are carried out at step S1 and step S2. Then, at step S3, following the manager operation, the service registering/managing unit 34 decides whether the application for service utilization and the registration of service utilization are valid, by referring to the information stored in the user information database 37, the vehicle database 38, and the service provider information database 39.

In more detail, following the manager operation, the service registering/managing unit 34 compares the information stored in the user information database 37 and the vehicle database 38 with the information received from the user. Based on this comparison, the service registering/managing unit 34 decides whether the vehicle 2 is owned, managed, or used by the user. When the vehicle 2 is not owned, managed, or used by the user, the service registering/managing unit 34 rejects the service utilization application from the user. In this way, the service registering/managing unit 34 can prevent a third party from making an unauthorized access to the user-managed vehicle 2 (application for service utilization) and violating the privacy.

Next, following the manager operation, the service registering/managing unit 34 compares the information stored in the service provider information database 39 with the service provider ID received from the service provider. In this way, the service registering/managing unit 34 decides whether the service provider registered in the service provider information database 39 has registered the service utilization. When the service provider registered in the service provider information database 39 has not registered the service utilization, the manager assesses the service provider as described above.

When the service provider registered in the service provider information database 39 registers the service utilization, the service registering/managing unit 34 operates as follows. Following the manager operation, the service registering/managing unit 34 decides whether the user has applied for utilizing the service, based on the user individual information and the information of the vehicle 2 received from the service terminal 3. When the user has not applied for utilizing the service, the service registering/managing unit 34 prohibits the proceeding to the subsequent processing. With this arrangement, it is possible to prevent the service provider from freely accessing the vehicles 2 of unspecified number of users.

When it is decided at step S3 that the application for service utilization and the registration of service utilization are valid, the processing proceeds to the next step. At step S4, the service registering/managing unit 34 generates the service ID inherent to the service of which utilization is applied for. At the same time, the encryption key generating unit 33 generates the encryption key to encrypt/decrypt the information transmitted/received between the vehicle 2 and the service terminal 3. After the processing at step S4 is completed, the access right setting/managing unit 32 defines, at step S5, the contents of vehicle information (hereinafter denoted as accessible information) that is necessary to provide the service of which utilization is applied for, by referring to the service provider information database 39. In the present embodiment, the encryption key generating unit 33 generates the encryption key. As an alternative, the service provider can generate the encryption key, and transmit the generated encryption key to the managing terminal 4 at the time of executing the processing at step S2.

The accessible information is defined at step S5. At step S6, the communication unit 31 transmits the vehicle ID of the vehicle 2 owned by the user extracted from the vehicle database 38, the service ID generated in the processing at step S4, and the encryption key, to the service terminal 3. At step S7, the service terminal 3 stores the vehicle ID, the service ID, and the encryption key that are received, thereby setting the service to be provided to the user owning the vehicle 2.

When the processing at step S6 is completed, then, at step 8, the communication unit 31 transmits to the vehicle 2, the vehicle ID of the user-owned vehicle 2 extracted from the vehicle database 38, the center ID and the access right setting ID read from the center ID managing unit 36 and the access right setting/managing unit 32, the service provider ID, the service ID, the contents of the accessible information, and the encryption key generated by the encryption key generating unit 33. Based on this, the communication unit 31 accesses the vehicle 2.

The vehicle 2 receives the access from the communication unit 31 based on the processing at step S8. At step S9, the input/output control unit 22 of the vehicle 2 decides whether the access is made to the own vehicle, by referring to the vehicle ID stored in the vehicle ID managing unit 11. When the vehicle ID transmitted from the communication unit 31 coincides with the vehicle ID stored in the vehicle ID managing unit 11 and when it is decided that the access is made to the own vehicle, the access right managing unit 23 compares the center ID and the access right setting ID that are stored with the center ID and the access right setting ID that are transmitted from the communication unit 31. Based on this, the access right managing unit 23 decides whether the access from the managing terminal 4 is valid.

When the stored center ID and the access right setting ID coincide with the center ID and the access right setting ID that are transmitted from the communication unit 31 and also when it is decided that the access from the managing terminal 4 is valid, the processing proceeds to the next step. At step S10, the input/output control unit 22 transmits the service provider ID, the service ID, the contents of the accessible information, and the encryption key to the access right managing unit 23 and the encryption key managing unit 24 respectively.

When the processing at step S10 is completed, then, at step S11, the service registering/managing unit 34 stores the vehicle ID, the service provider ID, the service contents, and the service ID into the service registration information database 40 by relating these pieces of information to the service of which utilization is applied for. At step S12, the charging unit 35 charges the service provider based on the information registered in the service registration information database 40. Thus, the series of service contract processing is completed.

Service Provision Processing

Next, the operation of the information service system for vehicle 1 that executes the service provision processing B will be explained with reference to the flowchart shown in FIG. 4.

The service contracted by the service contract processing A is provided to the user as follows. First, at step S21, following the service provider operation, the service terminal 3 transmits to the vehicle 2, the service provider ID and the service ID encrypted by the encryption key generated by the encryption key generating unit 33. Based on this, the service terminal 3 requests the vehicle 2 for the access to the vehicle information. Upon reception of the information from the service terminal 3, at step S22, the encrypting/decrypting unit 25 decrypts the service provider ID and the service ID encrypted by using the encryption key stored in the encryption key managing unit 24. The access right managing unit 23 compares the service provider ID and the service ID that are stored with the service provider ID and the service ID that are decrypted, and decides whether the service provider has the right to access the vehicle information (authentication processing). When the stored service provider ID and the service ID coincide with the decrypted service provider ID and the service ID and also when it is decided that the service provider has the right to access the vehicle information, the access right managing unit 23 specifies the accessible information corresponding to the service provider ID and the service ID.

When the accessible information by the service provider is specified, then at step S22, the encrypting/decrypting unit 25 obtains the accessible information from the in-vehicle network via the interface 12, and encrypts the obtained accessible information by using the encryption key stored in the encryption key managing unit 24. Upon encryption of the accessible information, at step S24, the communication unit 15 transmits the encrypted accessible information to the service terminal 3. At step S25, the service terminal 3 decrypts the encrypted accessible information using the encryption key, and obtains the accessible information from the vehicle. At step S26, the service provider provides the service to the user owning the vehicle 2 by using the obtained accessible information.

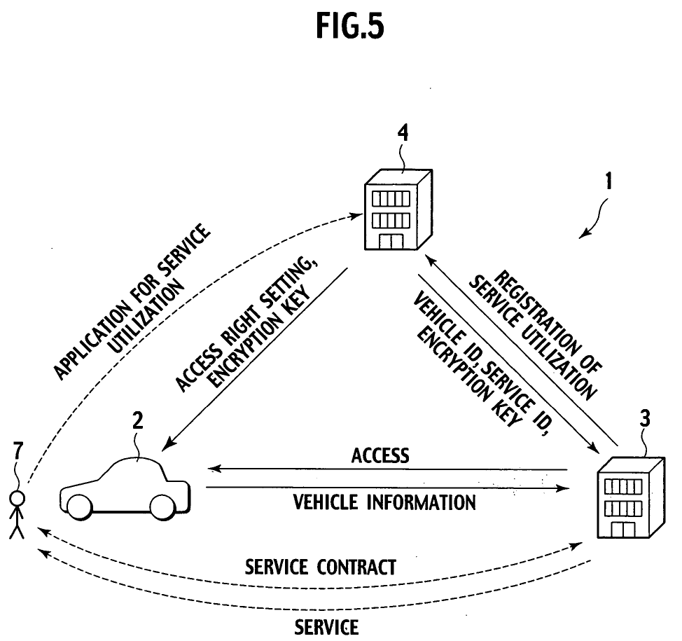

As is clear from the above explanation, the information service system for vehicle 1 according to the embodiment of the present invention operates as shown in FIG. 5. Upon reception of the service utilization registration from the service terminal 3 managed by the service provider, the managing terminal 4 transmits to the service terminal 3, the vehicle ID of the vehicle 2 owned by the user 7 who receives the service, the service provider ID given inherently to each service provider, and the service ID given inherently to each service. Upon reception of the service utilization application from the user 7, the managing terminal 4 transmits to the vehicle 2, the service provider ID transmitted to the service terminal 3, the service ID, and the vehicle information necessary to provide the service of which utilization is applied for. The service provider provides the service to the user as follows. The service terminal 3 accesses the vehicle 2 by using the service provider ID and the service ID. When the access to the vehicle 2 is authenticated, the managing terminal 4 reads the vehicle information necessary to provide the service of which utilization is applied for, and transmits the vehicle information to the service terminal 3. According to the configuration of the information service system for vehicle 1 of the embodiment of the present invention, since the managing terminal 4 manages the access to the in-vehicle network 13 for each service provider while maintaining security, installation of the vehicle equipment exclusive for each service is not necessary. Therefore, the workload and cost of the service provider and the user receiving the service can be reduced.

Further, according to the information service system for vehicle 1 of the embodiment of the present invention, the managing terminal 4 generates the inherent encryption key to encrypt/decrypt the information, and transmits the generated encryption key to the vehicle 2 and the service terminal 3. The vehicle 2 and the service terminal 3 encrypt/decrypt the information by using the received encryption key to carry out information-communications. Therefore, the vehicle 2 and the service terminal 3 can transmit/receive the vehicle information obtained from the in-vehicle network 13 via the electric communication line 5 while maintaining security.

Further, according to the information service system for vehicle 1 of the embodiment of the present invention, the managing terminal 4 operates upon reception of the requests from both the user of the vehicle 2 and the service provider. Therefore, it is possible to prevent a third party from making an unauthorized access to the user-managed vehicle 2 and violating the privacy. Further, a free access of the service provider to the vehicles 2 of unspecified number of users can be prevented.

While the embodiment of the present invention provided by the inventors is explained above, the description and the drawings of the embodiment that form a part of the disclosure of the invention do not limit the present invention. For example, in the above embodiment, the vehicle 2 and the service terminal 3 carry out the information-communications to each other according to a secret key method using the same key for the encryption and the decryption. However, the present invention is not limited to this method. An open key method for carrying out the encryption and the decryption by using two keys can be used to perform information-communications between the vehicle 2 and the service terminal 3, instead of the secret key method. It is needless to mention that other embodiments and implementation techniques that may occur to those skilled in the art based on the above embodiment are all included in the scope of the present invention.

The entire content of a Patent Application No. TOKUGAN 2003-344351 with a filing date of Oct. 2, 2003, is hereby incorporated by reference.

1. An information service system for vehicle that obtains vehicle information from vehicle equipment, and provides a service to a vehicle user by using the obtained vehicle information, the system comprising:
means for providing the service, installed at the side of a service provider; and
means for giving inherent identification information to the means for providing the service, and transmitting to the vehicle the identification information and accessible information that specifies the vehicle information necessary to provide the service by relating the identification information and the accessible information to each other, wherein
at the time of obtaining the vehicle information from the vehicle equipment, means for providing the service transmits the given identification information to the vehicle, and the vehicle specifies the vehicle information to be transmitted to the means for providing the service, according to the identification information received from the means for providing the service and the related accessible information, and transmits the specified vehicle information to the means for providing the service.

2. An information service system for vehicle that obtains vehicle information from vehicle equipment, and provides a service to a vehicle user by using the obtained vehicle information, the system comprising:
a first processor that is installed at the side of a service provider that provides the service; and
a second processor that gives inherent identification information to the first processor, and transmits to the vehicle the identification information and accessible information that specifies the vehicle information necessary to provide the service by relating the identification information and the accessible information to each other, wherein
at the time of obtaining the vehicle information from the vehicle equipment, the first processor transmits the given identification information to the vehicle, and the vehicle specifies the vehicle information to be transmitted to the first processor, according to the identification information received from the first processor and the related accessible information, and transmits the specified vehicle information to the first processor.

3. An information service system for vehicle according to claim 2, wherein
the second processor generates a key to encrypt and decrypt the information, and transmits the generated key to the vehicle and the first processor, and the vehicle and the first processor encrypt and decrypt the information to be transmitted and received by using the received key, and carry out information-communications.

4. An information service system for vehicle according to claim 2, wherein
the second processor operates following the reception of requests from both the vehicle user and the service provider.

5. An information service system for vehicle according to claim 2, wherein
the second processor charges the first processor following the giving of the identification information.

6. An information service system for vehicle according to claim 2, wherein
the vehicle equipment is connected to an in-vehicle network.
